(19) United States
(12) Patent Application Publication
(10) Pub. No.: US 2023/0062876 A1
(43) Pub. Date: Mar. 2, 2023

(54) METHOD OF MANUFACTURING HIGH-DENSITY YF3 COATING LAYER BY USING HVOF, AND HIGH-DENSITY YF3 COATING LAYER MANUFACTURED THROUGH SAME

(71) Applicant: KOMICO LTD., Anseong-si (KR)

(72) Inventors: Seong Sik BANG, Anseong-si (KR); Ki Won Hong, Anseong-si (KR); Donghuh Jeong, Anseong-si (KR)

(21) Appl. No.: 17/978,163

(22) Filed: Oct. 31, 2022

(30) Foreign Application Priority Data
Jan. 11, 2021 (KR) 10-2021-0147736

(51) Int. Cl. C23C 4/04; C23C 4/12; C01F 17/265

(52) U.S. Cl. CPC C23C 4/04; C23C 4/12; C01F 17/265

(57) ABSTRACT

The proposed is a manufacturing method for a high-density YF₃ coating layer by high-velocity oxygen fuel spraying (HVOF). More particularly, proposed is a manufacturing method for a high-density YF₃ coating layer by HVOF, in which YF₃ powder is melted and quenched to form densified spherical YF₃ particles and then the YF₃ particles are applied by HVOF to form a high-density YF₃ coating layer with improved mechanical properties and plasma resistance.

### CROSS REFERENCE TO RELATED APPLICATION

The present application claims priority to Korean Patent Application No. 10-2021-0147736, filed Nov. 1, 2021, the entire contents of which is incorporated herein for all purposes by this reference.

### BACKGROUND OF THE INVENTION

### Field of the Invention

The present invention relates generally to a manufacturing method for a high-density YF₃ coating layer by high-velocity oxygen fuel spraying (HVOF). More particularly, the present invention relates to a manufacturing method for a high-density YF₃ coating layer by HVOF, the method being capable of forming a high-density YF₃ coating layer with improved mechanical properties and plasma resistance by HVOF using YF₃ powder.

### Description of the Related Art

In recent years, the technology of high integration of semiconductor processes and ultra-fine line width has led to the need for a plasma etching process under extreme environments such as high-density plasma, high cleanliness, and excessive electric shock. In particular, a plasma etching process using a reactant gas containing a halogen element such as F, Cl, or Br with strong chemical reactivity involves etching of various deposition materials on a wafer surface. The reactant gas chemically and physically reacts with metal or ceramic components inside a chamber, causing damage to the surface of the components and generation of non-volatile contaminants.

Thus, interest in applying a coating of ceramic materials that exhibit excellent plasma resistance to the surface of metal or ceramic components has been greatly increased. As a representative coating material, yttrium oxide (Y₂O₃) is widely applied.

Yttrium oxide (Y₂O₃) is a material that exhibits high melting point (2,450° C.), chemical stability, and crystallographic stability up to 2300° C. In particular, due to its excellent chemical stability against F radicals, high ion bombardment resistance due to high atomic mass of yttrium, and excellent mechanical properties, Y₂O₃ exhibits excellent plasma resistance. However, Y₂O₃ reacts with plasmatized etching gas such as SF₆, CF₄, CHF₃, and HF on the surface of an Y₂O₃ coating layer at the beginning of the etching process, causing a change in the concentration of the etching gas in the chamber (change in the concentration of fluorine-based gas).

Therefore, there is a problem in that the seasoning time of the etching process is increased, and contaminant particles containing fluorine are formed on the surface of Y₂O₃.

In an attempt to solve the above problem, YF₃ with excellent corrosion resistance has been introduced. However, when YF₃ is applied by atmospheric plasma spraying (APS), YF₃ is melted by ultra-high-temperature plasma during the coating process and a part of fluoride (F) is oxidized, resulting in formation of a coating layer in which fluoride and oxide are partially mixed and thereby reducing corrosion resistance. Also, the coating layer thus formed has low mechanical strength compared to a thermal sprayed Y₂O₃ coating layer, so generation of cracks in the coating layer and particles in an etching chamber is increased.

As described above, the mechanical properties and plasma resistance of YF₃ are highly dependent on the thermal spray coating method. Therefore, there is a need for an optimal thermal spray coating method for forming a coating layer with improved physical properties and plasma resistance by improving the problems of YF₃.

In general, thermal spray coating methods used for applying yttrium compounds include flame spraying (FS), high-velocity oxygen fuel spraying (HVOF), suspension plasma spraying (SPS), and atmospheric plasma spraying (APS), etc. Of these, APS is representatively used.

However, when YF₃ is applied by APS, YF₃ is melted by plasma at an excessively high temperature compared to its melting point, and a part of YF₃ is converted into Y₂O₃ as the degree of oxidation is increased. As a result, the content of F in a formed coating layer becomes different from the original content and the density of the coating layer is reduced. This causes a problem in that the desired corrosion resistance is not met. In addition, the oxidation of YF₃ to Y₂O₃ leads to a change in the crystal structure and thereby lowers the density of the formed coating layer. This phenomenon is pronounced in the case of APS coating. Therefore, applying of YF₃ through APS has a fatal disadvantage in that a coating layer containing 100% YF₃ cannot be formed.

In order to solve such a problem, applying of YF₃ through SPS capable of forming a high-density coating layer may be considered. However, in the case of SPS, it is difficult to form a 100% YF₃ coating layer because oxidation occurs due to the use of high plasma energy for complete volatilization of solvent.

Accordingly, there may be considered HVOF capable of improving the problems of APS coating, foaming a high-density coating layer like SPS, and improving process efficiency by melting particles with a relatively low-temperature flame. HVOF is a method of generating a high-speed jet by burning fuel gas together with oxygen at high pressure. While HVOF is difficult to apply to ceramic materials such as Y₂O₃ and YAG, which require a high temperature of 2,000° C. or more, a high-density coating layer similar to that formed by SPS can be obtained because YF₃ has a relatively low melting point of about 1,300° C. compared to other ceramic materials.

In this regard, Japanese Patent No. 6929718 (registration date: Aug. 13, 2021) discloses an HVOF coating method using a raw material including orthorhombic YF₃. However, the spraying distance (distance from a nozzle tip of an HVOF device to a substrate) during

HVOF coating needs to be set as short as 20 to 250 mm because the density of YF₃ is low. In addition, in the case of a thermal sprayed film formed by HVOF, the ratio of orthorhombic YF₃ to YOF is 18:82, so the YF₃ content is not high. In particular, an annealing process is required to improve the stability of the formed thermal sprayed film.

As described above, to form a coating layer by HVOF, coating powder particles to be fed need to have a high density so as to have sufficient kinetic energy to fly to a coating surface. This calls for an improved process capable of increasing the density of commonly used low-density YF₃ powder.

Accordingly, the present inventors have developed a manufacturing method for a high-density YF₃ coating layer by HVOF to increase the density of YF₃-based powder itself when forming an YF₃ coating layer by HVOF, thereby optimizing the mechanical properties, chemical stability, and plasma resistance of the YF₃ coating layer.

The foregoing is intended merely to aid in the understanding of the background of the present invention, and is not intended to mean that the present invention falls within the purview of the related art that is already known to those skilled in the art.

### DOCUMENTS OF RELATED ART

(Patent document 1) Japanese Patent No. 6929718 (registration date: Aug. 13, 2021)

### SUMMARY OF THE INVENTION

Accordingly, the present invention has been made keeping in mind the above problems occurring in the related art, and an objective of the present invention is to provide a manufacturing method for a high-density YF₃ coating layer by HVOF, in which YF₃-based powder itself is modified to have increased density and improved physical properties and then applied by HVOF, thereby reducing the degree of oxidation during coating, suppressing the loss of the F component, and densifying the coating layer, so that the mechanical properties and plasma resistance of the coating layer are improved.

Another objective of the present invention is to provide a high-density YF₃ coating layer manufactured by the manufacturing method for the high-density YF₃ coating layer by HVOF.

In order to achieve the above objectives, according to one aspect of the present invention, there is provided a manufacturing method for a high-density YF₃ coating layer by high velocity oxygen fuel spraying (HVOF), the method including the steps of: (a) feeding YF₃ powder into a plasma jet and melting the YF₃ powder; (b) preparing spherical YF₃ particles by spraying molten YF₃ droplets to a refrigerant; (c) removing the refrigerant after step (b) and drying the spherical YF₃ particles; and (d) applying YF₃ powder particles formed in step (c) to a substrate by HVOF.

As one embodiment, in step (b), a distance from a spray outlet to a surface of the refrigerant may be 400 to 600 mm when the molten YF₃ droplets are sprayed, and the refrigerant may be any one or more selected from H₂O, N₂, and Ar.

As one embodiment, a particle size of the spherical YF₃ particles in step (d) may be 10 to 60 μm, and the HVOF in step (d) may be performed under conditions of an oxygen gas flow rate of 1900 to 2500 SCFH and a fuel rate of 4 to 6 GPH.

According to another aspect of the present invention, there is provided a high-density YF₃ coating layer manufactured by the above-described method. As one embodiment, the high-density YF₃ coating layer may be composed of Y, O, and F, contain O in an amount of 6 to 8 at %, and contain F in an amount of 61 to 65 at %, and the high-density YF₃ coating layer may have a porosity of less than 1% and a hardness of 400 to 500 Hv.

According to the present invention, YF₃ powder is subjected to spheroidizing to have increased density and improved physical properties and then applied by HVOF, whereby a high-density YF₃ coating layer with improved mechanical properties can be formed. In particular, the use of HVOF coating can reduce the loss of the F component of YF₃ particles and improve plasma resistance.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 a schematic diagram illustrating a preparation method for a spherical YF₃ powder according to an embodiment of the present invention;

FIG. 2 is a flowchart illustrating a manufacturing method for a high-density YF₃ coating layer by HVOF according to the present invention;

FIG. 3 illustrates SEM images of YF₃ powder particles before/after spheroidizing according to an embodiment of the present invention; and

FIG. 4 illustrates SEM images of each coating layer formed from a spheroidized or non-spheroidized YF₃ powder by different plasma spray coating methods according to an embodiment of the present invention.

### DETAILED DESCRIPTION OF THE INVENTION

Unless otherwise defined, all terms including technical and scientific terms used herein have the same meaning as commonly understood by one of ordinary skill in the art to which this invention belongs. Generally, the nomenclature used herein and the laboratory procedures described below are those well known and commonly employed in the art.

It will be further understood that the terms “comprise”, “include”, and/or “have”, when used herein, specify the presence of stated features, integers, steps, operations, elements, and/or components, but do not preclude the presence or addition of one or more other features, integers, steps, operations, elements, components, and/or groups thereof.

In one aspect, the present invention provides a manufacturing method for a high-density YF₃ coating layer by HVOF, the method comprising the steps of: (a) feeding YF₃ powder into a plasma jet and melting the YF₃ powder; (b) preparing spherical YF₃ particles by spraying molten YF₃ droplets to a refrigerant; (c) removing the refrigerant after step (b) and drying the spherical YF₃ particles; and (d) applying YF₃ powder particles formed in step (c) to a substrate by high-velocity oxygen fuel spraying (HVOF).

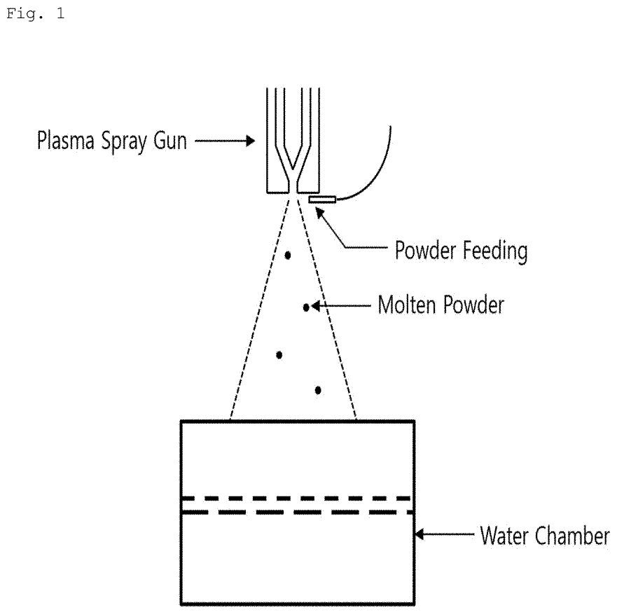

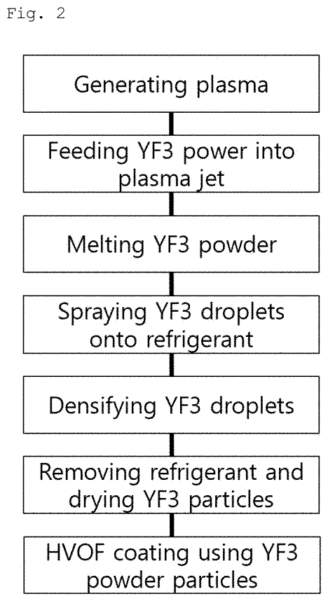

FIG. 1 a schematic diagram illustrating a preparation method for a spherical YF₃ powder according to an embodiment of the present invention. FIG. 2 is a flowchart illustrating the manufacturing method for the high-density YF₃ coating layer by HVOF according to the present invention. Referring to these drawings, a description will be given in detail below.

In the present invention, step (a) is a step of feeding the YF₃ powder into the plasma jet and melting the YF₃ powder.

Plasma refers to a state in which a gas is heated by extremely high-temperature energy and separated into charged electrons and ions, and a plasma jet refers to a plasma in the form of a spray. In step (a) of the present invention, the YF₃ powder is fed into the plasma jet to melt the YF₃ powder within a short period of time.

At this time, the temperature of the plasma jet is high enough to melt the YF₃ powder, and may be adjusted in consideration of the melting point of the YF₃ powder.

Then, step (b) is a step of preparing the spherical YF₃ particles by spraying the molten YF₃ droplets to the refrigerant. When the molten YF₃ droplets are sprayed to the refrigerant, the distance from a spray outlet for the YF₃ droplets to the surface of the refrigerant is set to 400 to 600 mm.

Specifically, the distance means the distance from the spray outlet of a plasma spray gun to the surface of the refrigerant, and is set to 400 to 600 mm to ensure that the molten YF₃ droplets are sprayed to the refrigerant without loss to improve the yield and exhibit a quenching effect. When the distance is less than 400 mm, the loss of solvent and powder due to spraying pressure is significant, and on the other hand, when it exceeds 600 mm, the yield is reduced due to spraying angle and it is difficult to achieve a sufficient quenching effect of molten powder. Preferably, the distance is 400 to 500 mm.

In addition, the refrigerant quenches the sprayed molten YF₃ droplets to make them spherical and dense. Specifically, during the process of quenching the molten YF₃ droplets rapidly sprayed to the refrigerant, the YF₃ droplets become spherical to minimize surface energy and are densified at the same time, thereby improving hardness. At this time, the refrigerant may be any one or more selected from H₂O, N₂, and Ar, and in general, the refrigerant is distilled water at room temperature.

Then, step (c) is a step of removing the refrigerant after step (b) and drying the spherical YF₃ particles. The refrigerant removal and drying of the spherical YF₃ powder may be performed by a conventional method, so detailed descriptions thereof will be omitted. At this time, the drying time or drying temperature is not limited because it may vary depending on the evaporation temperature according to the type of refrigerant. For example, when the refrigerant is distilled water, the drying may be performed at a temperature of 100° C. to 120° C. for at least 15 hours.

The YF₃ powder particles formed in step (c) has a particle size of 10 to 60 μm. In general, the smaller the particle size of the YF₃ powder particles, the denser a coating layer can be formed. However, when the particle size is less than 10 μm, cohesive force is generated due to a close inter-particle distance, making it technically difficult to feed the powder. On the other hand, and it exceeds 60 μm, the coating layer cannot be formed at high density. Therefore, the particle size of the YF₃ powder particles is 10 to 60 μm, preferably 24 to 45 μm.

Steps (a) to (c) are a process of spheroidizing and densifying the YF₃ powder, that is, powder particles including the F component. In order to secure corrosion resistance against HF that may be generated in a series of processes, in all or some processes, a container to be used is coated with a Teflon coating of equal to or greater than 50 μm or is made of a ceramic material.

Finally, step (d) is a step of applying the YF₃ powder particles formed in step (c) to the substrate by high-velocity oxygen fuel spraying (HVOF).

HVOF is a thermal spray technology whereby powder or precursor is converted into molten droplets using a high-temperature heat source, and then and then the droplets are quenched and solidified by colliding with a substrate at high speed to form a laminated film. It is a method that requires a high density of powder or precursor to form a coating layer. Specifically, a film is formed by burning fuel gas (propane, methylacetylene, heptane, and hydrogen) together with oxygen at high pressure to generate a high-speed jet of 2000 m/s, which is used as a heat source. As a result, it is possible to manufacture a dense coating layer that exhibits excellent bonding strength and improved fatigue properties and thermal shock resistance.

Furthermore, since the YF₃ powder particles are applied by such HVOF in step (d), it is possible to solve the problem in which when forming a conventional F-based coating layer, the content of F is reduced as the degree of oxidation is increased due to a high-temperature plasma atmosphere. In other words, when the YF₃ powder particles are applied by HVOF in step (d), the degree of oxidation is reduced during coating because a relatively low heat source is used compared to a conventional plasma spraying method. Thus, it is possible to increase the F content and control the element composition ratio. In addition, in the case of HVOF, the size of scattered splats formed as a result of collision of the droplets accelerated at a very high speed is reduced, leading to a reduction in the size of generated particles. This is advantageous in terms of improving the mechanical properties of the coating layer compared to the conventional plasma spraying method.

In order to generate a high-temperature/high-pressure flame by burning fuel and oxygen, HVOF may be performed under the following conditions. That is, the oxygen gas flow rate may be 1800 to 2000 SCFH, the fuel rate may be 4 to 6 GPH, and the fuel may be kerosene, propane, propylene, acetylene, hydrogen, or the like. The high-density YF₃ coating layer manufactured by the above method has a porosity of less than 1%. Due to its high density, the hardness of the coating layer is significantly increased to 400 to 500 Hv. Also, the coating layer has a high content of F because it is manufactured by HVOF using a relatively low-temperature heat source and thus the degree of oxidation is reduced during coating.

In other words, the high-density YF₃ coating layer may include F in an amount of 61 to 65 at % and O in an amount of 6 to 8 at %.

Consequently, the high-density YF₃ coating layer manufactured by the above method has improved mechanical strength, improved ion bombardment resistance during dry etching, and significantly improved plasma resistance.

Hereinafter, the present invention will be described in more detail by way of Examples, but the present invention is not limited by these Examples.

### EXAMPLE

### 1. Preparation Example

### (1) Spheroidizing of YF₃ Powder

### Preparation Examples 1 to 7: Spheroidizing of YF₃ Powder

A commercially available YF₃ powder was subjected to spheroidizing according to the schematic diagram illustrated in FIG. 1 and the flowchart illustrated in FIG. 2.

Referring to FIGS. 1 and 2, a plasma was generated in a plasma device first, and then the YF₃ powder was fed into a plasma jet and heated uniformly. At this time, the spraying conditions such as the plasma formation condition, the type of fuel gas, and the like were as illustrated in Table 1 below.

Then, the heated YF₃ powder was sprayed in the form of molten droplets onto the surface of a refrigerant (water) spaced a distance of 200 to 800 mm apart from a spray outlet to quench the YF₃ droplets, after which the YF₃ was separated from water and dried. A densified spherical YF₃ powder was obtained through the above process. Each spherical YF₃ powder of Preparation Examples 1 to 7 was prepared according to the distance.

TABLE 1

| Voltage (V) | Current (A) | Power (kW) | Ar(NLPM) | H₂ (NLPM) |
|---|---|---|---|---|
| 75~78 | 600~610 | 44~48 | 40~44 | 9~13 |

### Control 1

A commercially available YF₃ powder not subjected to spheroidizing was used as Control 1.

Table 2 below illustrates the yield of each spheroidized YF₃ powder of Preparation Examples 1 to 7 prepared according to the distance from the spray outlet to the refrigerant.

TABLE 2

| | Distance (mm) | Yield (%) |
|---|---|---|
| Preparation | 200 | Not measurable |
| Example 1 | | |
| Preparation | 300 | 70 |
| Example 2 | | |
| Preparation | 400 | 84 |
| Example 3 | | |
| Preparation | 500 | 90 |
| Example 4 | | |
| Preparation | 600 | 87 |
| Example 5 | | |
| Preparation | 700 | 80 |
| Example 6 | | |
| Preparation | 800 | 75 |
| Example 7 | | |

### 2. Analysis of Sphericity and Density of Spheroidized YF₃ Powder

### (1) Yield According to Distance

Table 2 above illustrates the yield of each spheroidized YF₃ powder of Preparation Examples 1 to 7 prepared according to the distance from the spray outlet for spraying YF₃ droplets to the refrigerant. As can be seen from Table 1, when the distance is 400 to 600 mm, YF₃ can be densified through spheroidizing.

### (2) SEM Image

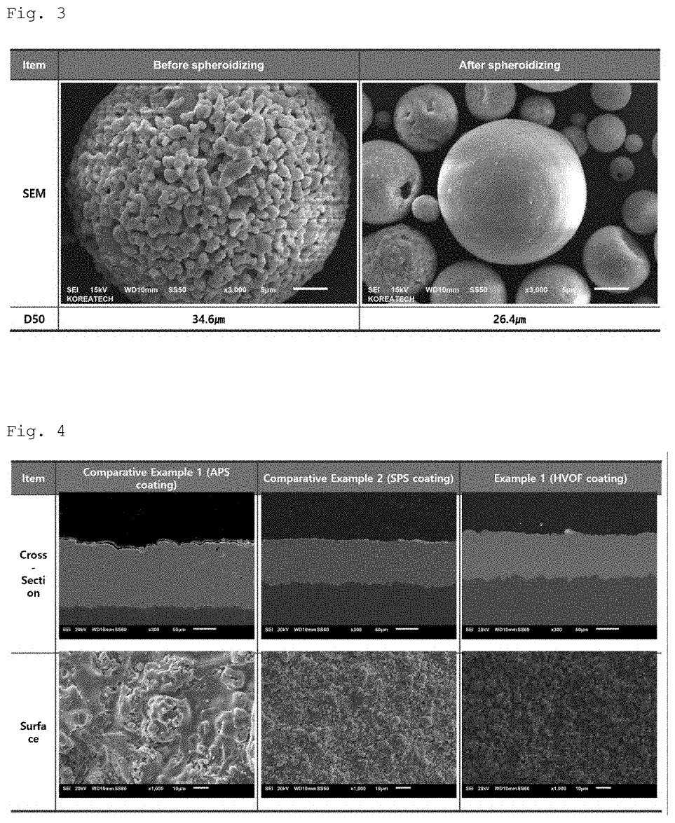

FIG. 3 illustrates SEM images of the YF₃ powder before spheroidizing (Control 1) and the YF₃ powder after spheroidizing (Preparation Example 4). As can be seen from FIG. 3, the YF₃ powder becomes spherical in shape and densified through spheroidizing.

In other words, the YF₃ powder (Control 1) before spheroidizing had a non-spherical shape and had a D50 of 34.6 μm, whereas the YF₃ powder (Preparation Example 4) after spheroidizing had a spherical shape and was densified to have a D50 of 26.4 μm.

### 3. Formation of YF₃ Coating Layer

### Example 1: Formation of YF₃ Coating Layer Using HVOF Device

The prepared spherical YF₃ powder (Preparation Example 4) was applied using an HVOF device (Praxair, JP5220). At this time, a high-speed flame was generated under the conditions of oxygen 2,000 SCFH (standard cubic feet of gas per hour) and kerosene 6 GPH (gallon per hour).

Comparative Example 1: Formation of non-spheroidized YF₃ coating layer using atmospheric plasma spraying (APS) device

The non-spheroidized YF₃ powder of Control 1 was applied using an APS device (OerlikonMetco, F4MB). At this time, a plasma was generated under the conditions of a voltage of 80.0 V, a current of 600 A, and a gas supply of argon gas 40 NLPM and hydrogen gas 8 NLPM. Comparative Example 2: Formation of non-spheroidized YF₃ coating layer using suspension plasma spraying (SPS) device

The non-spheroidized YF₃ powder of Control 1 was applied using an SPS device (Progressive, 100HE). At this time, a plasma was generated under the conditions of a voltage of 285.0 V, a current of 380 A, and a gas supply of argon gas 340 SCFH, nitrogen gas 100 SCFH, and hydrogen gas 80 SCFH.

### 4. Coating Layer Analysis According to Plasma Spray Coating Method

### (1) Physical Properties

Table 3 below and FIG. 4 illustrate a comparison of the physical properties (hardness, porosity, and surface roughness), and coating state of each coating layer formed from the spherical or non-spherical spherical YF₃ powder by different plasma spray coating methods.

TABLE 3

| | | Comparative | Comparative |
|---|---|---|---|
| | Example 1 | Example 1 | Example 2 |
| Item | (HVOF coating) | (APS coating) | (SPS coating) |
| Hardness (Hv) | <500 | <300 | <500 |
| Porosity (%) | <1% | <3% | <1% |
| Surface | 2~3 | 3~4 | 1~2 |
| roughness (μm) | | | |

As can be seen from Table 3 and FIG. 4, in the case of Example 1 formed by HVOF coating using the spherical YF₃ powder, the porosity and surface roughness are reduced, the hardness is significantly increased, and the density is increased compared to Comparative Example 1 formed by APS coating using the non-spherical YF₃ powder. This result was due to the fact that the YF₃ powder was highly densified through spheroidizing. Furthermore, the high densification of YF₃ through spheroidizing made it possible to use the HVOF coating method.

Meanwhile, in the case of Example 1 formed by HVOF coating using the spherical YF₃ powder, similar physical properties are exhibited and the density is increased compared to Comparative Example 2 formed by SPS coating using the non-spherical YF₃ powder.

### (1) XPS

Table 4 below illustrates XPS analysis results of each coating layer formed from the spheroidized or non-spheroidized YF₃ powder by different plasma spray coating methods.

TABLE 4

| Component ratio | Compound | Unit | O | F | Y |
|---|---|---|---|---|---|
| Example 1 (HVOF) | YF₃ | at. % | 7.1 | 63.4 | 29.5 |
| Comparative | | | 6.5 | 62.2 | 31.3 |
| Example 1 (APS) | | | | | |
| Comparative | | | 11.2 | 59.4 | 29.4 |
| Example 2 (SPS) | | | | | |

As can be seen from Table 4 above, in the case of Example 1 formed by HVOF coating using the spheroidized YF₃ powder, the O content is low while the F content is high compared to Comparative Example 2 formed by SPS coating using the non-spheroidized YF₃ powder. This is because, since HVOF coating uses a relatively low-temperature heat source compared to SPS coating, the degree of oxidation is low, which is advantageous for the formation of F-based coating layers.

Meanwhile, in the case of Example 1 formed by HVOF coating using the spheroidized YF₃ powder, the F content is similar compared to Comparative Example 1 formed by APS coating using the non-spheroidized YF₃ powder.

From the analysis results, it is revealed that in the case of HVOF coating using the spheroidized YF₃ powder, the physical properties are significantly improved compared to APS coating using the non-spheroidized YF₃ powder, and a coating layer having a low O content and a high F content can be formed compared to SPS coating using the spheroidized YF₃ powder.

Thus, when the spheroidized YF₃ powder is applied by HVOF, a coating layer having a high F content while having high mechanical properties can be formed.

Although referred embodiments of the present invention have been described for illustrative purposes, those skilled in the art will appreciate that various modifications, additions, and substitutions are possible, without departing from the scope and spirit of the present disclosure as disclosed in the accompanying claims.

What is claimed is:

1. A manufacturing method for a high-density YF₃ coating layer by high velocity oxygen fuel spraying (HVOF), the method comprising the steps of:
(a) feeding YF₃ powder into a plasma jet and melting the YF₃ powder;
(b) preparing spherical YF₃ particles by spraying molten YF₃ droplets to a refrigerant;
(c) removing the refrigerant after step (b) and drying the spherical YF₃ particles; and
(d) applying YF₃ powder particles formed in step (c) to a substrate by HVOF,
wherein in step (b), a distance from a spray outlet to a surface of the refrigerant is 400 to 600 mm when the molten YF₃ droplets are sprayed.

2. The method of claim 1, wherein the refrigerant is any one or more selected from H₂O, N₂, and Ar.

3. The method of claim 1, wherein a particle size of the spherical YF₃ particles in step (d) is 10 to 60 μm.

4. The method of claim 1, wherein the HVOF in step (d) is performed under conditions of an oxygen gas flow rate of 1900 to 2500 SCFH and a fuel rate of 4 to 6 GPH.

5. A high-density YF₃ coating layer manufactured by the method of claim 1.

6. The YF₃ coating layer of claim 5, wherein the high-density YF₃ coating layer is composed of Y, O, and F, contains O in an amount of 6 to 8 at %, and contains F in an amount of 61 to 65 at %.

7. The YF₃ coating layer of claim 5, wherein the high-density YF₃ coating layer has a porosity of less than 1% and a hardness of 400 to 500 Hv.
